(19) United States
(12) Patent Application Publication
(10) Pub. No.: US 2006/0123554 A1
(43) Pub. Date: Jun. 15, 2006

(54) Method of graphically coloring leather

(76) Inventor: Thomas Kerle, Furth (DE)

Correspondence Address: LERNER GREENBERG STEMER LLP, P O BOX 2480, HOLLYWOOD, FL, 33022-2480, US

(21) Appl. No.: 11/273,149

(22) Filed: Nov. 14, 2005

(30) Foreign Application Priority Data
Nov. 12, 2004 (DE) 10 2004 054 828.5

(51) Int. Cl. C14C 1/00

(52) U.S. Cl. 8/94.15

(57) ABSTRACT

The invention relates to a process for imagewise dyeing of leather. In a first step (10), a mordant comprising acrylates or polyacrylates is applied to a leather (1). After a drying and curing time, a further step (12) comprises applying a water-soluble dye to the leather (1) by means of a transfer, the dye being initially applied to the transfer by a digital printing process and in the course of being transferred from the transfer to the leather (1) binding reactively with the latter and with the mordant penetrated thereinto.

This invention relates to a process for imagewise dyeing of leather, i.e., for generating colored motific structures on leather.

A process for dyeing and printing of leather is known from DE 38 25 755 A1 for example. It utilizes anionic metal complex dyes comprising metal complexes of metallizable monoazo and/or monoazomethine dyes. In the known process the leather is further treated with a polymer obtainable for example by reaction of a monofunctional or polyfunctional amine with, inter alia, cyanamide, dicyandiamide, guanidine or biguanidine. Further reaction is possible for example with formaldehyde or a formaldehyde-releasing compound.

A further important aspect of dyeing leather is the structure of the dyed surface as well as the identity of the often environmentally hazardous chemicals used. The leather surface, which has a typical structure in the undyed state, frequently has applied to it a layer which evens out the natural unevenness of the leather and thus tends to create the impression of a smooth plastics surface. The leather is accordingly more coated than dyed. Coating has the further disadvantage that the coating tears very readily, in particular under bending stress, and therefore is barely suitable for permanent stressing as in the case of shoes for example. For the reasons mentioned, imagewise dyeing of highly stressed leather is generally not undertaken and instead uniformly dyed leather is used.

The present invention has for its object to provide a leather-dyeing process that combines good environmental compatibility with high stability of the dyeing coupled with substantial preservation of the typical surficial structure of leather. We have found that this object is achieved by a process according to claim 1 and also by a leather according to claim 25.

The process of the present invention comprises a first step of applying a mordant comprising acrylates and/or polyacrylates to a leather. After a drying and curing time, a further step comprises applying a water-soluble dye to the leather by means of a transfer. The motific structure in which the leather is to be dyed is initially printed onto the transfer, i.e., onto a paper, film, foil or other sheetlike article. The image or other motific structure is transferred from the transfer to the leather. The transfer is printed in a digital printing process, similarly to the customary printing of paper, and hence is particularly efficient while at the same time providing a high achievable definition. The dye transferred from the transfer to the leather binds reactively with the leather and with the mordant penetrated thereinto. In this way, the leather is dyed imagewise while its surface structure is substantially preserved and at the same time good durability, especially colorfastness and abrasion resistance, is ensured.

Leathers dyeable with the process are grain leathers, for example sheep, goat or cattle nappa and willow calf or boxside leathers, and also such as for example suede leather, suede split and nubuck leather. The process for imagewise dyeing can be used on any tanned leathers, for example mineral-, syn- or combination-tanned leathers. The process is similarly useful for leathers in various thicknesses, such as bookbinder leather, glove leather, shoe leather, leather for bags, shoe sole leather, upholstery leather, suitcase leather, belt leather or leather for sports goods. The disclosed process is also particularly useful for dyeing previously colored leathers.

The mordant to be used in the first step of the process can be applied to the leather by spread coating, brush coating, knife coating, roller coating, spraying or in some other way, for example by dipping. During the subsequent drying time, the mordant distributes in the leather and binds with the leather surface without however destroying its surface structure as for example through formation of an uninterrupted, even layer. The drying is accompanied by a curing of the mordant in the leather, in particular through polymerization reactions.

The liquid comprising acrylates or polyacrylates which is used as a mordant makes possible by virtue of its chemical composition a reaction with the leather and also with the applied dye and hence in a particularly environment-friendly process a permanent dyeing of the leather.

So-called mordant dyes are preferred in that they have very surprisingly been determined to be particularly useful for imagewise dyeing of leather. Mordant dyes, although widely used since the middle ages, are now comparatively rarely used on account of their technical inconvenience. Mordant dyes belong to various chemical classes and have hitherto almost exclusively been used in the textile industry, chiefly for dyeing wool, silk, cellulosics and other proteinaceous fibers. Mordant dyes used herein are not to be confused with the dye stains which are well known for use as colorants for wood in particular.

Further advantageous embodiments of the invention are apparent from the subclaims. Advantageously, the dye binds to the leather reactively by dyeing groups coupling to OH groups in the leather. Leather of animal origin bears these OH groups as protein constituents. The dyes couple to the OH groups to form a durable bond which is stabilized through the simultaneous presence of the acrylates or polyacrylates. The dyes are durably and stably conjoined with the leather and not with an interlayer applied atop the leather, preserving the natural surficial constitution of the leather.

Claims 3 to 8 concern particularly preferred embodiments of the invention where in each case the use of a selected mordant contributes to the process of the present invention being particularly environment friendly. The mordant used is preferably oil free and, apart from water, comprises no inorganic constituents whatsoever, such as for example no chromium, nickel or silicon in concentrations relevant to the performance of the mordant. The use of poisonous solvents is therefore not required. The solids content of the mordant preferably varies in the range between 30% and 70%. A solids content of about 60% to 65% will prove particularly advantageous. However, even a low solids content of about 30% will still provide qualitatively adequate results, depending on the planned application. The use of a waterborne mordant makes the process of the present invention applicable even in critical sectors, for example in the food sector. The mordant in the form of an aqueous dispersion is preferably poison free (butyl acrylate, for example, is merely classed as an irritant, hazard symbol “Xi”) and biodegradable, so that the disposal of remaining stocks in particular presents no problem. The use of a waterborne mordant in conjunction with the water-soluble dye leads in particular to the reactive bond of the dye with the OH groups of the leather being preferentially formed. This is further promoted by the relatively low solids content of the mordant.

In one preferred operative example of the invention, the ready-produced mordant is obtained from a mordant concentrate, which is diluted with water. The mordant concentrate preferably consists of 60% to 90% by weight of ethyl acrylate and 10% to 40% by weight of butyl acrylate, which is mixed with water. This concentrate is then diluted with water in a ratio of 1:3 to 1:5 before use. Owing to the polymerization reactions, it is not in every case possible to determine the solids content of the ready-produced mordant arithmetically from the composition of the starting materials. The mordant employed in the process has an autogenous solids content of about 63%.

The solvent-free mordant (water is not deemed a solvent in this context) is preferably transparent or at least has such little color that the use of the mordant does not restrict the possibilities of subsequent dyeing of the leather, especially not a high-definition dyeing. The mordant can also have been admixed with chemical or physical additives (claims 9 and 10). For example, the mordant may be thickened with thickeners and hence be formulated for brush coating or knife coating application. In any event, all the chemicals used in the process of the present invention are generally recognized as safe from environmental, occupational safety and health viewpoints.

In one advantageous embodiment of the invention, the dye and/or mordant has been applied such that the dyed leather acquires a neutral pH of about 7. Extensive investigations have revealed that the pH of the dyed leather is of importance for the stability of the reactive bond with the leather and the mordant. If the color is applied without regard to the pH, an acidic pH has to result in the leather. This is because commercially available leather inherently has an acidic pH in the range between 3 and 4. However, an acidic pH can have an adverse effect on the stability of the reactive bond, in particular on the stability of the bond with the OH groups of the leather. If the color and/or mordant is applied in an alkaline range, with a pH of about 7.5 to 9, then the dyed leather has an approximately neutral pH. This enhances the durability of the reactive bond of the dye.

The entire fraction of the mordant that is accounted for by the acrylates and the polyacrylates is preferably less than 40% (claim 12). Preferred parameters for treating the leather after the mordant has been applied and before the dye is applied are identified in claims 13 to 14. The leather is dried at 100° C. to 150° C. and in particular at about 130° C. These temperatures keep the energy consumption relatively low. Alternatively, it is also possible to perform the drying at room temperature. When the drying is effected at the identified temperatures above room temperature, it takes about 10 min to about 60 min and in particular about 30 min. After this drying operation, the leather pieces which have been treated with the mordant can already be stacked.

The curing of the acrylates and polyacrylates in the mordant, involving a polymer's self-crosslinking reaction, takes half a minute to two minutes and in particular about 1 min at temperatures of 130° C. to 170° C. The drying and curing times can transition seamlessly into one another, in which case the temperature during the curing time is not necessarily higher than during the preceding drying time. In any event, the particularities of the leather, in particular its limited thermal stability, must be heeded by choosing suitable parameters.

The dye used preferably has a solids content of less than 15% by weight and hence is particularly suitable for the digital printing process. The dye concerned is a water-soluble dye without use of organic solvents (claims 16 and 17). The use of quinoline, which is used for preparing inhibited metal-pickling compositions, for treating the leather is possible (claim 18).

The dye may have been admixed with chemical and/or physical additives such as for example defoamers and fillers in order that the leather surface may be modified or for example the formation of a protective layer on the leather surface is supported (claim 19). The dye applied to the leather is, if not dried at room temperature, preferably dried at 100° C. to 150° C. and in particular about 130° C. for half a minute to two minutes and in particular for about 1 min (claim 20).

It is a particular advantage to transfer the dye from the transfer to the leather by vapor deposition. Vaporization or sublimation can be used to convert the dye into the gaseous state and hence the transfer be used as a sublimation element. The transferring of the dye onto the leather can here be effected by means of a heatable press, for example a veneering press as used in the same or similar form by joiners and carpenters. The dye will sublime under the influence of the requisite pressure and temperature values. Sublimation in this connection is to be understood as meaning not just in the physically strict sense of a transition from the solid into the gaseous phase, but also an entraining of dye particles in a water vapor stream produced by the heating without necessarily a phase change of the dye particles taking place (claims 21 to 23).

The dye particles are detached from the sublimation element previously placed on the leather to be dyed and are applied to the leather. The sublimation element serves as a carrier material for the dye. At the same time, any water still present will evaporate from the mordant previously applied to the leather. The mordant, the dye and the leather become reactively conjoined such that, after the pressing operation has ended, the dye is firmly and irretrievably located in the leather. After the dye has been applied, a thin protective layer or a lacquer, for example PU, can be applied to the leather in order that the surface may additionally be protected against environmental influences and wear. It is preferable to apply a coating of an aqueous dispersion of self-crosslinking polymers (claim 24). Even with this additional coating the natural, structured surface of the leather remains substantially unaffected.

The present process provides a particularly environment-friendly and hence up-to-date way of dyeing leather. At the same time, the process is completely safe healthwise. Unlike existing processes, which cover the leather to which a print is to be applied with a smooth coating, the leather surface is not covered or sealed by a colored print. On the contrary, the dyeing is the result of the chemicals used passing into the leather to produce a qualitatively high-value dyeing. A particular feature of the dyeing result is that the surface character and the haptics of the leather are fully preserved and the motific structure thus produced is color- and lightfast.

The present dyeing process also makes it possible in principle to endow large areas of leather articles with a uniform coloration or with coarse colored structures. However, the advantages of the process become particularly apparent when it is used to apply picture motifs having very fine motific structures on the order of a few millimeters in magnitude in that the colors do not flow into each other. The process has a low consumption of dye, is particularly simple to carry out and hence is economical. It can be carried out using existing processing machines and equipment, so that introducing the process, or switching from existing processes to the process of the present invention, is possible without major capital costs. The visually very appealing results survive even prolonged use of the dyed leather article.

The invention will now be described with reference to an operative example which is illustrated by the drawings, where

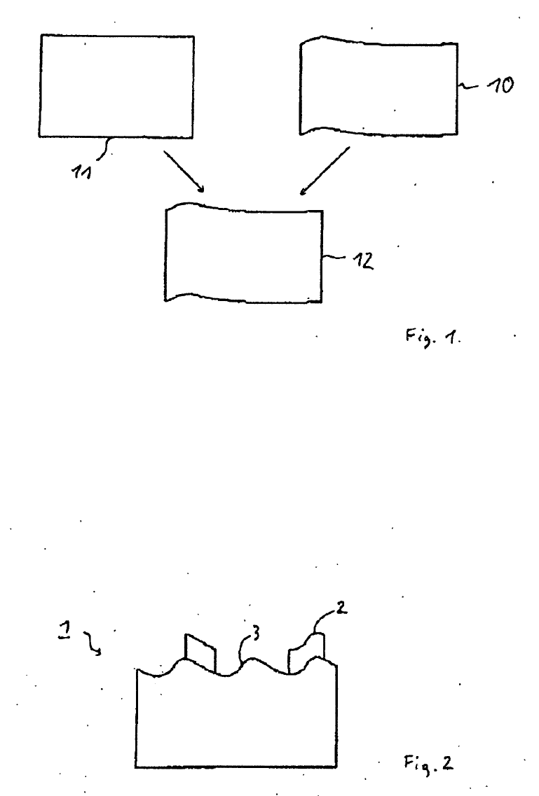

FIG. 1 shows a simplified flow diagram of the inventive process and

FIG. 2 shows a schematic depiction of part of a leather dyed with the inventive process.

FIG. 1 shows a schematically much simplified flow diagram of the inventive process. A first step 10 comprises applying an oil-free mordant in the form of an aqueous dispersion having a solids content of 63% to a piece of leather to be treated, and which is intended for example for manufacturing sports shoes. The mordant, apart from water, is virtually free of inorganic constituents and is obtained from a mordant concentrate which consists of 70% by weight of ethyl acrylate and 30% by weight of butyl acrylate and is diluted with water in a ratio of 1:4. After the mordant has been applied to the leather, the mordant which has penetrated into the substrate surface is dried. The drying can take place at room temperature, so that no energy costs are generated for drying. Alternatively, the drying operation can take place at elevated temperatures, for example in the range from 100° C. to 150° C. Depending on the drying temperature, the drying time is between a few minutes and some hours. In addition to drying, the mordant undergoes curing in the first step 10, the chemicals present in the mordant polymerizing wholly or partly. To cure the mordant, the leather is preferably brought to a temperature of up to 170° C., which is higher than the drying temperature, and the curing operation takes about one minute only.

In a preparing step 11 which can be performed concurrently to applying and drying the mordant to the leather, the motific structure which is ultimately to be transferred to the leather is printed onto a transfer, preferably paper. A digital printing process as is in principle common practice for example in the case of commercially available ink jet printers and plotters is employed. Herein, digital printing does not exclusively refer to a printing process wherein a pixelated image is processed by data technology, but also encompasses vector graphics for example. A digital printing process as the term is used herein subsumes any printing process wherein a print master is digitally stored and the printing machine is controlled with the aid of a computer. If the image is present as a pixelated graphic, the dye is preferably applied to the transfer line by line. The same applies mutatis mutandis in cases where the motific structure is a piece of writing or a combination of writing and graphic representation. The dye used is preferably a water-soluble, solvent-free digital printing ink which has a solids content of below 15% and does not include anthraquinones and alizarins.

After the conclusion of the first step 10 of the process, i.e., of the treatment of the leather with the mordant in the form of an aqueous dispersion of acrylates and polyacrylates, and also of the preparing step 11, i.e., the digital printing of the transfer, a further step 12 comprises transferring the motific structure from the transfer to the pretreated leather.

The dye on the transfer is transferred to the leather in a sublimation process by the printed paper, the film, foil or the like, which serves as transfer, being placed on the leather and heated under pressure. Finally, the transfer is peeled off to leave only the color on the leather. This ensures optimal durability and colorfastness without essentially impairing the surface structure of the leather. More particularly, the formation of a smooth, plasticky layer on the leather surface is avoided.

The described operation of vapor depositing or subliming the dye onto the leather in step 12 suitably utilizes for example a customary heatable press. Typical press temperatures are a press pressure of 5 to 15 bar and also a temperature of for example 180° C., which can be achieved through electrical heating. Instead of an electrically heatable press it is obviously also possible to use other suitable apparatuses that allow vaporization of the dye and incorporation of the dye in the leather and also a reactive bond between the mordant, the dye and the leather. If the mordant has not completely polymerized in the first step 10, a further polymer's self-crosslinking reaction takes place in step 12 to additionally contribute to binding the dye in the leather.

A final step, not illustrated, may be carried out to cover the dyed surface of the leather with a protective layer which, like the layer formed by the mordant, is formed of self-crosslinking polymers and likewise is colorless.

FIG. 2 finally shows in cross section a highly schematicized depiction of a leather 1 which has been dyed imagewise using the process described above. The mordant applied to the leather 1 in step 10 has become conjoined to the leather 1 and therefore is not depicted as a separate layer. The dye transferred, in step 12, to the leather 1 combines with the latter and with the mordant to form a color layer 2 which is depicted in simplified form as a separate layer on the surface 3 of the leather 1. The leather 1, as is distinctly visible in the cross-sectional view, has an uneven surface 3. As is further discernible, the color layer 2 conforms to the unevennesses in the surface 3 of the leather 1, the color layer 2 being in fact so thin that, insofar as it is geometrically separate from leather 1 at all, it is barely perceivable haptically.

This even makes possible an imagewise dyeing with high definition, for example a photographic representation, without complete levelization of the surface 3 of the leather 1.

### LIST OF REFERENCE NUMERALS

1. leather
2. color layer
3. surface
10. first step
11. preparing step
12. further step

1. A process for imagewise dyeing of leather, the process comprising a first step (10) of applying to a leather (1) a mordant comprising acrylates or polyacrylates and, after a drying and curing time, a further step (12) of applying a water-soluble dye to the leather (1) by means of a transfer, the dye being initially applied to the transfer by a digital printing process and in the course of being transferred from the transfer to the leather (1) binding reactively with the latter and with the mordant penetrated thereinto.

2. A process according to claim 1,
characterized in that
the dye binds reactively with the OH groups in the leather.

3. A process according to claim 1 or 2,
characterized in that
the mordant is oil free.

4. A process according to any one of claims 1 to 3,
characterized in that
the mordant is free of inorganic constituents.

5. A process according to any one of claims 1 to 4,
characterized in that
the mordant has a solids content of less than 70%.

6. A process according to any one of claims 1 to 5,
characterized in that
the mordant has a solids content of at least 30%.

7. A process according to any one of claims 1 to 6,
characterized in that
the mordant is an aqueous dispersion.

8. A process according to any one of claims 1 to 7,
characterized in that
the mordant is solvent free.

9. A process according to any one of claims 1 to 8,
characterized in that
the coating of the leather (1) with the mordant is transparent.

10. A process according to any one of claims 1 to 9,
characterized in that
the mordant has been admixed with chemical or physical additives.

11. A process according to any one of claims 1 to 10,
characterized in that
the dye and/or the mordant is applied such that the dyed leather acquires a neutral pH of about 7.

12. A process according to any one of claims 1 to 11,
characterized in that
the total fraction of the mordant that is accounted for by the acrylates and polyacrylates is less than 40%.

13. A process according to any one of claims 1 to 12,
characterized in that
the mordant-treated leather (1) is dried at 100° C. to 150° C. and in particular at about 130° C.

14. A process according to any one of claims 1 to 13,
characterized in that
the drying of the mordant applied to the leather (1) takes 10 min to 60 min and in particular about 30 min.

15. A process according to any one of claims 1 to 14,
characterized in that
the mordant applied to the leather (1) is cured at 130° C. to 170° C. for half a minute to 2 minutes and in particular for about 1 minute in the form of a polymer's self-crosslinking reaction.

16. A process according to any one of claims 1 to 15,
characterized in that
the solids content of the dye is less than 15%.

17. A process according to any one of claims 1 to 16,
characterized in that
the dye is free of organic solvents.

18. A process according to any one of claims 1 to 17,
characterized by
the use of quinoline for treating the leather (1).

19. A process according to any one of claims 1 to 18,
characterized in that
the dye is admixed with chemical and/or physical additives such as for example defoamers, fillers, etc.

20. A process according to any one of claims 1 to 19,
characterized in that
the dye applied to the leather (1) is dried at 100° C. to 150° C. and in particular at about 130° C. for half a minute to 2 min and in particular for about 1 min.

21. A process according to any one of claims 1 to 20,
characterized by
the dye present on the transfer being vapor deposited onto the leather (1).

22. A process according to any one of claims 1 to 21,
characterized in that
the transfer provided with the dye is used as a sublimation element.

23. A process according to any one of claims 1 to 22,
characterized by
the use of a heatable press to transfer the dye from the transfer to the leather (1).

24. A process according to any one of claims 1 to 23,
characterized in that,
after the dye has been applied, an additional coating of an aqueous dispersion of self-crosslinking polymers is applied to the leather (1).

25. Imagewise dyed leather (1)
produced by
a process according to any one of claims 1 to 24.
